(19) United States
(12) Patent Application Publication
(10) Pub. No.: US 2016/0212206 A1
(43) Pub. Date: Jul. 21, 2016

(54) DETERMINISTIC DATABASE SYSTEM AND DATA TRANSFERRING METHOD THEREOF

(71) Applicant: National Tsing Hua University, Hsinchu City (TW)

(72) Inventors: Shan-Hung Wu, Hsinchu (TW); Meng-Kai Liao, Hsinchu County (TW); Shao-Kan Pi, Taichung City (TW); Yu-Shan Lin, Taichung City (TW)

(21) Appl. No.: 14/693,903

(22) Filed: Apr. 23, 2015

(30) Foreign Application Priority Data
Jan. 21, 2015 (TW) 104101943

(51) Int. Cl. H04L 29/08; G06F 17/30; H04L 12/26

(52) U.S. Cl. CPC H04L 67/1095; H04L 43/0876; G06F 17/30377

(57) ABSTRACT

A deterministic database system and a data transferring method thereof are provided. The method includes monitoring a workload of a resource server or a candidate server. When the workload meets a transferring requirement, the resource server starts to copy data to the candidate server. During copying the data, the resource server and the candidate server execute transactions together according to an execution order of the transactions, and then reply an execution result.

### CROSS-REFERENCE TO RELATED APPLICATION

This application claims the priority benefit of Taiwan application serial no. 104101943, filed on Jan. 21, 2015. The entirety of the above-mentioned patent application is hereby incorporated by reference herein and made a part of this specification.

### BACKGROUND OF THE INVENTION

1. Field of the Invention

The invention relates to a database system and a data processing method thereof and particularly relates to a deterministic database system and a data transferring method thereof.

2. Description of Related Art

A distributed database system is composed of a plurality of servers that are disposed at different locations. Each server has a built-in database management system (DBMS) and has a database of its own. The servers at different locations are connected with one another via a network to constitute one complete database.

Most on-line transactions in the databases are directed to only a small amount of data in a partial database. Thus, using the distributed configuration can reduce the costs for data transfer and improve the system reliability. Even if some servers fail, other servers would not be affected and can remain operation for the partial database.

However, in certain special circumstances, on-line transactions may be made in one specific server (for example, the number of queries may increase significantly if an important event occurs) and cause the workload of the specific server to surge and delay the processing of the transactions. In such cases, it is necessary to use other servers to share the workload of the specific server. Before processing the transactions, the other servers need to obtain data required for processing the transactions from the original server. Therefore, an operation of transferring the data needs to be carried out first. However, in order to prevent the data transfer from being affected by execution of the transactions and to avoid data inconsistency, current database system would suspend the transactions during the data transfer and resume the transactions after the data transfer is completed. During the suspension, the user may sense shutdown of the system services and have a bad impression.

### SUMMARY OF THE INVENTION

The invention provides a deterministic database system and a data transferring method thereof for continuing executing transactions while transferring data.

The invention provides a deterministic data transferring method for transferring at least one piece of data from a resource server to a candidate server. In the method, a workload of the resource server or the candidate server is monitored, and whether the workload meets a transferring requirement is determined. The resource server starts to copy the data to the candidate server if the workload meets the transferring requirement. The resource server and the candidate server execute a plurality of transactions together according to an execution order of the transactions during copying the data and reply an execution result of each of the transactions.

In an embodiment of the invention, after the step that the resource server and the candidate server execute the transactions together according to the execution order of the transactions and reply the execution result of each of the transactions, the method further includes that the resource server deletes the data after completing copying the data.

In an embodiment of the invention, the step of monitoring the workload of the resource server or the candidate server and determining whether the workload meets the transferring requirement includes that: the candidate server monitors the workload of the resource server and determines whether the workload exceeds a transfer upper limit to determine whether the workload meets the transferring requirement.

In an embodiment of the invention, the step of monitoring the workload of the resource server or the candidate server and determining whether the workload meets the transferring requirement includes that: the resource server monitors the workload of the candidate server and determines whether the workload is below a transfer lower limit to determine whether the workload meets the transferring requirement.

In an embodiment of the invention, before the step that the resource server and the candidate server execute the transactions together according to the execution order of the transactions, the method further includes that: a management server receives the transactions, assigns each of the transactions an index in a total execution order following which the transactions are executed, and provides the indexes to the resource server and the candidate server for executing the transactions.

In an embodiment of the invention, before the step that the resource server and the candidate server execute the transactions together according to the execution order of the transactions, the method further includes that: the resource server and the candidate server receive the transactions and assign each of the transactions an index in a total execution order following which the transactions are executed.

In an embodiment of the invention, after the step that the resource server and the candidate server execute the transactions together according to the execution order of the transactions, the method further includes that: the resource server transmits the execution result of the transaction to the candidate server; and the candidate server temporarily stores the execution result received from the resource server and, after receiving the data required for executing the transaction, updates the received data according to the execution result.

The invention provides a deterministic database system that includes a resource server and a candidate server. The resource server stores at least one piece of data. The candidate server monitors a workload of the resource server and copies the data of the resource server if the workload exceeds a transfer upper limit. The resource server and the candidate server execute a plurality of transactions together according to an execution order of the transactions during copying the data and reply an execution result of each of the transactions.

The invention further provides a deterministic database system that includes a resource server and a candidate server. The resource server stores at least one piece of data, monitors a workload of the candidate server, and copies the data to the candidate server if the workload is below a transfer lower limit. The resource server and the candidate server execute a plurality of transactions together according to an execution order of the transactions during copying the data and reply an execution result of each of the transactions.

In an embodiment of the invention, the resource server further deletes the data when completing copying the data.

In an embodiment of the invention, the deterministic database system further includes a management server receiving the transactions, assigning each of the transactions an index in a total execution order following which the transactions are executed, and providing the indexes to the resource server and the candidate server for executing the transactions.

In an embodiment of the invention, the resource server and the candidate server receive the transactions and assign each of the transactions an index in a total execution order following which the transactions are executed.

In an embodiment of the invention, the resource server transmits the execution result of the transaction to the candidate server, and the candidate server temporarily stores the execution result received from the resource server and, after receiving the data required for executing the transaction, updates the received data according to the execution result.

Based on the above, according to the deterministic database system and the data transferring method of the invention, the resource server and the candidate server execute the transactions together while transferring data from the resource server to the candidate server, and then reply an execution result. As the amount of the data copied to the candidate server increases, execution of the subsequent transactions is gradually transferred from the resource server to the candidate server, so as to reduce the workload of the resource server. In addition, if the transactions are executed by the resource server, the resource server further transmits the execution result to the candidate server when the execution is completed, for the candidate server to update the received data. Thereby, consistency of the data before and after the transfer is ensured.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a diagram showing a deterministic database system according to an embodiment of the invention.

FIG. 2 is a flowchart showing a deterministic data transferring method according to an embodiment of the invention.

FIG. 3 is a diagram showing a deterministic database system according to an embodiment of the invention.

FIG. 4 is a diagram showing a deterministic database system according to an embodiment of the invention.

FIG. 5 is a flowchart showing a method by which a resource server executes a transaction according to an embodiment of the invention.

### DESCRIPTION OF THE EMBODIMENTS

The invention monitors system workloads of individual database servers in a distributed manner, such that when data is transferred for adjusting the number of the database servers, the original database is able to continue executing transactions and transmit an execution result to a candidate server. Thereby, the user may not feel suspension of the system services during the data transfer. Since the invention monitors the system workloads of the database servers in a distributed manner rather than a single-monitoring manner, favorable usability and expansibility are achieved.

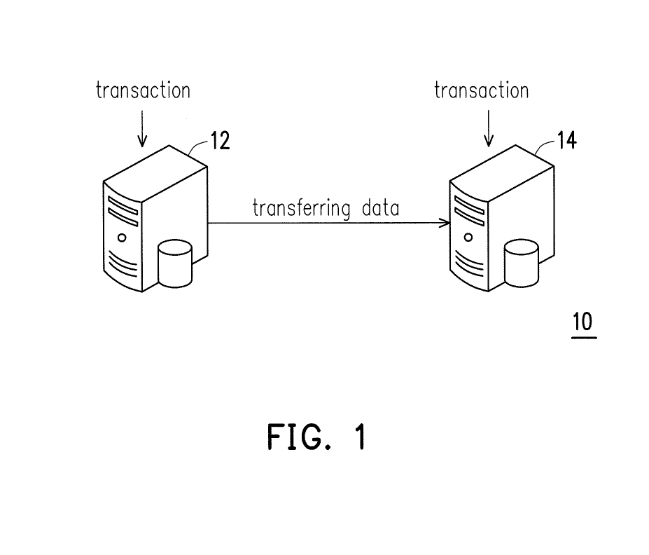

FIG. 1 is a schematic diagram showing a deterministic database system according to an embodiment of the invention. With reference to FIG. 1, a deterministic database system 10 of this embodiment includes a resource server 12 and a candidate server 14. The deterministic database system 10 may further include a plurality of candidate servers that function the same as or similar to the candidate server 14 to share a workload of the resource server 12. Thus, only the candidate server 14 is described hereinafter as an example. For example, the resource server 12 and the candidate server 14 are database servers that use a relational database management system, such as MySQL, PostgreSQL, and Microsoft SQL Server, which are connected through a network for transmitting data to each other. In this embodiment, when the workload of the resource server 12 or the candidate server 14 meets a predetermined requirement, the deterministic database system 10 transfers at least one piece of data from the resource server 12 to the candidate server 14, so as to reduce the load of the resource server 12. During the data transfer, the resource server 12 and the candidate server 14 execute transactions together, and the server that completes the transactions first replies an execution result.

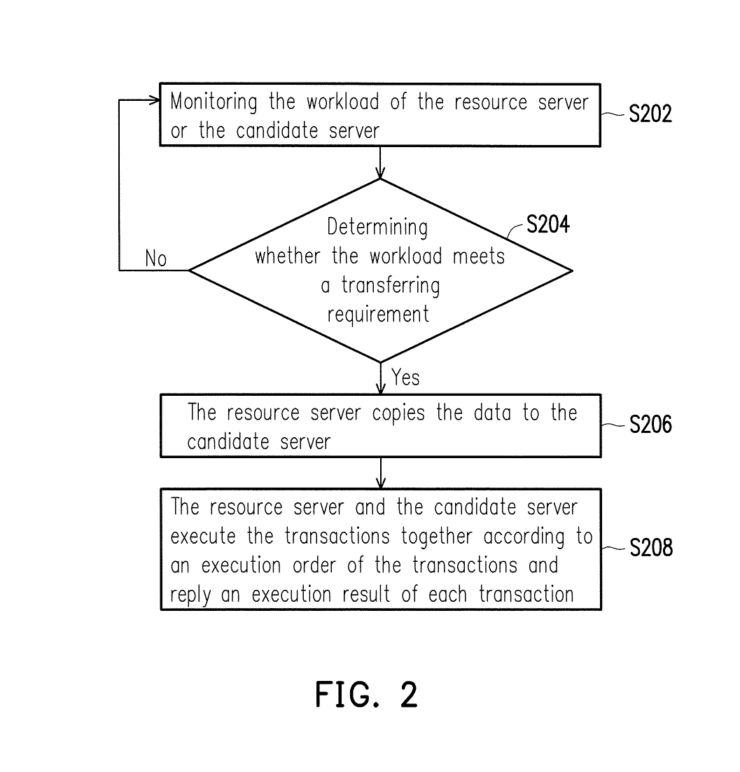

Specifically, FIG. 2 is a flowchart showing a deterministic data transferring method according to an embodiment of the invention. With reference to FIG. 1 and FIG. 2, the method of this embodiment is suitable for the deterministic database system 10 described above. Detailed steps of the data transferring method of the embodiment are described below with reference to the components of the deterministic database system 10 in FIG. 1.

First, the deterministic database system 10 monitors the workload of the resource server 12 or the candidate server 14 (Step S202) and determines whether the monitored workload meets a transferring requirement (Step S204). In this embodiment, the unit that monitors the workload may be the resource server 12 or the candidate server 14, but is not limited thereto. By the resource server 12 and the candidate server 14 monitoring each other, distributed monitoring of the database servers is achieved to enhance the usability and expansibility.

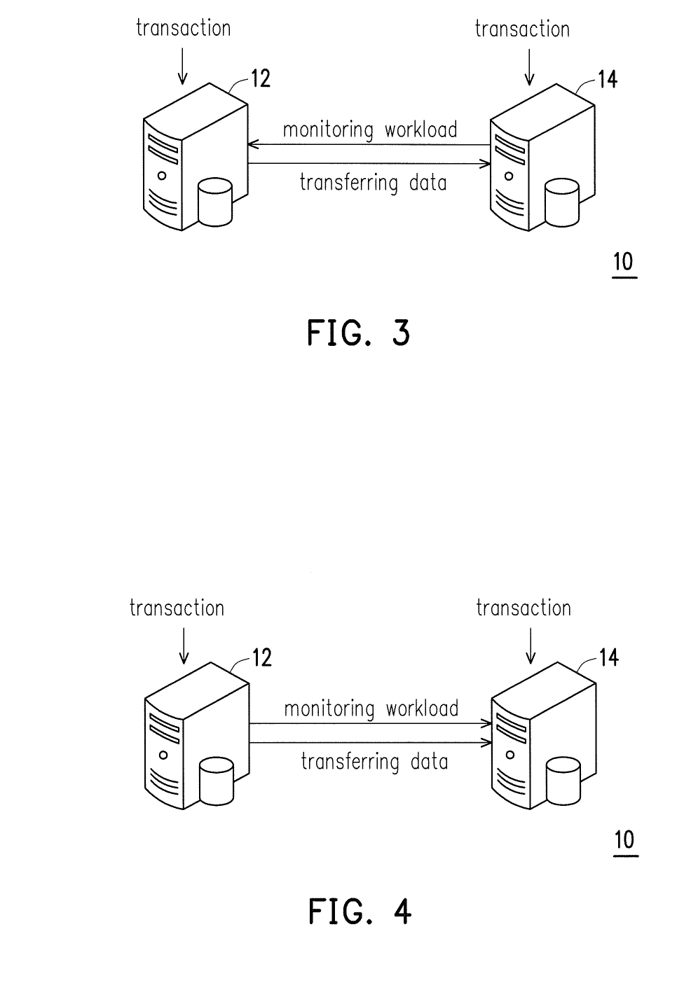

More specifically, FIG. 3 and FIG. 4 are diagrams respectively showing the deterministic database system according to an embodiment of the invention. FIG. 3 illustrates a situation where the candidate server 14 monitors the resource server 12. To be more specific, the candidate server 14 monitors the workload of the resource server 12 and determines whether the workload exceeds a transfer upper limit, so as to determine whether the workload meets the transferring requirement, which requires data transfer. The transfer upper limit serves as a basis for determining whether the server is overloaded. A value of the transfer upper limit may be adjusted by database management staff, and the invention is not limited thereto. In contrast, FIG. 4 illustrates a situation where the resource server 12 monitors the candidate server 14. To be more specific, the resource server 12 monitors the workload of the candidate server 14 and determines whether the workload is below a transfer lower limit, so as to determine whether the workload meets the transferring requirement, which allows data transfer thereto. The transfer lower limit serves as a basis for determining whether the server is underloaded. A value of the transfer lower limit may also be adjusted by database management staff, and the invention is not limit thereto.

Reverting to FIG. 2, if the deterministic database system 10 determines that the monitored workload does not meet the transferring requirement, the procedure of the method returns to Step S202 to continue monitoring the workload of the resource server 12 or the candidate server 14. On the other hand, if the deterministic database system 10 determines that the monitored workload meets the transferring requirement, the resource server 12 starts to copy data to the candidate server 14 (Step S206). For example, the resource server 12 first transfers the most important data to the candidate server 14 according to the importance of the data to be transferred (e.g. the data that is frequently accessed or was accessed recently), so as to share the load of the resource server 12 efficiently.

During copying the data, the resource server 12 and the candidate server 14 receive a plurality of transactions and execute the transactions together according to an execution order of the transactions and then reply an execution result of executing each transaction (Step S208). The deterministic database system 10 of this embodiment is based on a deterministic concept that gives each of the transactions received on-line an index in a total execution order according to information, such as time and location of obtaining the transaction, so as to ensure that the transactions are processed in the same order in different servers. The total execution order can be generated independently using mechanisms such as Paxos or Zab, but is not limited thereto. In the aforementioned step, both the resource server 12 and the candidate server 14 reply the execution result to the user end after completing the execution of the transactions. Therefore, when the user end receives the first execution result, the execution of the transactions is deemed completed; and when the user end receives the second execution result, the second execution result is discarded directly.

The execution order may be further divided into a centralized deterministic type and a distributed deterministic type. In the case of the centralized deterministic type, the deterministic database system 10 receives on-line transactions through an independent management server (not shown), assigns each of the transactions an index in a total execution order following which the transactions are executed, and then provides the indexes to the resource server 12 and the candidate server 14 for executing the transactions. In the case of the distributed deterministic type, the deterministic database system 10 receives on-line transactions through the resource server 12, the candidate server 14, and other servers, and assigns each of the transactions an index in a total execution order following which the transactions are executed after communicating with the servers. Then, the resource server 12 and the candidate server 14 execute the transactions according to the execution order. Since the deterministic concept is used in this embodiment, the resource server 12 and the candidate server 14 execute the transactions in exactly the same execution order. Thus, the data consistency is maintained even after the resource server 12 and the candidate server 14 execute several transactions.

It should be noted that, in an embodiment, the resource server 12 and the candidate server 14 execute the transactions together, and if the candidate server 14 has not obtained the data required for executing the transactions when executing the transactions, the candidate server 14 waits until the resource server 12 copies the data to the candidate server 14 to start executing the transactions. Nevertheless, in another embodiment, the candidate server 14 may directly use the execution result of the resource server 12 to update the data that the candidate server 14 receives.

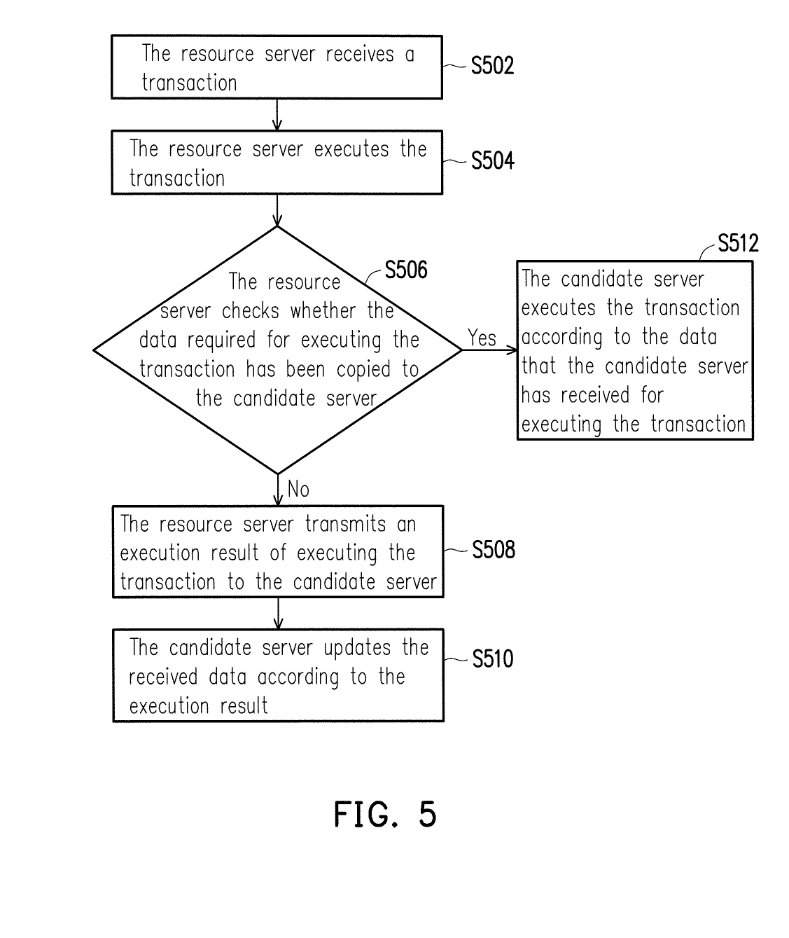

Specifically, FIG. 5 is a flowchart showing a method by which the resource server executes the transactions according to an embodiment of the invention. With reference to FIG. 1 and FIG. 5, the method of this embodiment is suitable for the resource server 12 described above and includes the following steps.

First, the resource server 12 receives a transaction (Step S502) and executes the received transaction (Step S504). For example, when copying data to the candidate server 14, the resource server 12 records the data that has been copied for review later.

Then, the resource server 12 reviews whether the data required for executing the transaction has been copied to the candidate server 14 (Step S506). If the resource server 12 finds that the data required for executing the transaction is not completely copied to the candidate server 14, it indicates that the candidate server 14 does not have the data required for executing the transaction at the moment and is unable to complete the transaction. Thus, the resource server 12 transmits an execution result of executing the transaction to the candidate server 14 (Step S508).

After obtaining the execution result, the candidate server 14 updates the data the candidate server 14 receives according to the execution result (Step S510). For example, the candidate server 14 temporarily stores the execution result received from the resource server 12 in a memory, a hard disk, or other storage media, and updates the received data according to the execution result after obtaining the data required for executing the transaction.

On the other hand, if the resource server 12 finds that the data required for executing the transaction has been copied to the candidate server 14, the resource server 12 does not transmit the execution result of executing the transaction to the candidate server 14, such that the candidate server 14 executes the transaction according to the data it has received (Step S512).

It should be noted that, in the case where the transaction is executed by the resource server 12, the candidate server 14 is unable to complete the transaction due to lack of the data required for executing the transaction. However, when the candidate server 14 receives the execution result provided by the resource server 12, the candidate server 14 is able to directly update the received data according to the execution result.

In addition, during copying the data and executing the transaction, the resource server 12 further determines whether the data to be transferred to the candidate server 14 has been completely copied. If the copying of the data is not completed, the resource server 12 and the candidate server 14 continue executing the transaction. If the copying of the data is completed, the resource server 12 deletes the data.

It should be noted that, in the above embodiment, the resource server 12 and the candidate server 14 both execute the transaction. Therefore, the workload of the resource server 12 is not reduced during the transfer. However, since the resource server 12 and the candidate server 14 both execute the transaction and reply the execution result, the user end would receive the result from the server that completes the execution faster. Hence, delay of execution of the transaction that the user may feel during the transfer is reduced. For example, if the transaction is only executed by the resource server 12, the workload of the resource server 12 may become excessively high and drag the execution speed. As a result, the user may sense longer execution time. By configuring the candidate server 14 to execute the transaction together with the resource server 12, since the candidate server 14 has less workload, the candidate server 14 is able to complete the execution faster and reply to the user earlier. Thus, the user may feel that the execution time is shorter.

By performing the aforementioned data transferring method of the invention, the processing of the transaction is maintained during the data transfer. Thus, the user does not feel service suspension. Once the data is copied to the candidate server, the resource server may delete the data that has been transferred. Thereby, the deterministic database system transfers the transactions related to the transferred data to the candidate server for execution, so as to effectively reduce the load of the resource server.

In conclusion, according to the deterministic database system and the data transferring method of the invention, the resource server and the candidate server execute the transactions together, so as to maintain the execution of the transaction during copying the data. Thus, the user does not feel service suspension. During the data transfer, the resource server records which data has been transferred to the candidate server, so as to determine whether to execute the transaction. Thereby, the load of the resource server is gradually reduced during the data transfer, and the correctness of the transferred data is ensured.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A deterministic data transferring method for transferring at least one piece of data from a resource server to a candidate server, comprising:
monitoring a workload of the resource server or the candidate server, and determining whether the workload meets a transferring requirement;
the resource server copying the data to the candidate server if the workload meets the transferring requirement; and
the resource server and the candidate server executing a plurality of transactions together according to an execution order of the transactions during copying the data and replying an execution result of each of the transactions.

2. The deterministic data transferring method according to claim 1, wherein after the step of the resource server and the candidate server executing the transactions together according to the execution order of the transactions and replying the execution result of each of the transactions, the deterministic data transferring method further comprises:
the resource server deleting the data when completing copying the data.

3. The deterministic data transferring method according to claim 1, wherein the step of monitoring the workload of the resource server or the candidate server and determining whether the workload meets the transferring requirement comprises:
the candidate server monitoring the workload of the resource server and determining whether the workload exceeds a transfer upper limit to determine whether the workload meets the transferring requirement.

4. The deterministic data transferring method according to claim 1, wherein the step of monitoring the workload of the resource server or the candidate server and determining whether the workload meets the transferring requirement comprises:
the resource server monitoring the workload of the candidate server and determining whether the workload is below a transfer lower limit to determine whether the workload meets the transferring requirement.

5. The deterministic data transferring method according to claim 1, wherein before the step of the resource server and the candidate server executing the transactions together according to the execution order of the transactions, the method further comprises:
a management server receiving the transactions, assigning each of the transactions an index in a total execution order following which the transactions are executed, and providing the indexes to the resource server and the candidate server for executing the transactions.

6. The deterministic data transferring method according to claim 1, wherein before the step of the resource server and the candidate server executing the transactions together according to the execution order of the transactions, the method further comprises:
the resource server and the candidate server receiving the transactions and assigning each of the transactions an index in a total execution order following which the transactions are executed.

7. The deterministic data transferring method according to claim 1, wherein after the step of the resource server and the candidate server executing the transactions together according to the execution order of the transactions, the method further comprises:
the resource server transmitting the execution result of the transaction to the candidate server; and
the candidate server temporarily storing the execution result received from the resource server and, after receiving the data required for executing the transaction, updating the received data according to the execution result.

8. A deterministic database system, comprising:
a resource server storing at least one piece of data; and
a candidate server monitoring a workload of the resource server and copying the data of the resource server if the workload exceeds a transfer upper limit,
wherein the resource server and the candidate server execute a plurality of transactions together according to an execution order of the transactions during copying the data and reply an execution result of each of the transactions.

9. The deterministic database system according to claim 8, wherein the resource server further deletes the data when completing copying the data.

10. The deterministic database system according to claim 8, further comprising:
a management server receiving the transactions, assigning each of the transactions an index in a total execution order following which the transactions are executed, and providing the execution order to the resource server and the candidate server for executing the transactions.

11. The deterministic database system according to claim 8, wherein the resource server and the candidate server receive the transactions and assign each of the transactions an index in a total execution order following which the transactions are executed.

12. The deterministic database system according to claim 8, wherein the resource server transmits the execution result of the transaction to the candidate server, and the candidate server temporarily stores the execution result received from the resource server and, after receiving the data required for executing the transaction, updates the received data according to the execution result.

13. A deterministic database system, comprising:
a candidate server; and
a resource server storing at least one piece of data, monitoring a workload of the candidate server, and copying the data to the candidate server if the workload is below a transfer lower limit,
wherein the resource server and the candidate server execute a plurality of transactions together according to an execution order of the transactions during copying the data and reply an execution result of each of the transactions.

14. The deterministic database system according to claim 13, wherein the resource server further deletes the data when completing copying the data.

15. The deterministic database system according to claim 13, further comprising:
a management server receiving the transactions, assigning each of the transactions an index in a total execution order following which the transactions are executed, and providing the indexes to the resource server and the candidate server for executing the transactions.

16. The deterministic database system according to claim 13, wherein the resource server and the candidate server receive the transactions and assign each of the transactions an index in a total execution order following which the transactions are executed.

17. The deterministic database system according to claim 13, wherein the resource server transmits the execution result of the transaction to the candidate server, and the candidate server temporarily stores the execution result received from the resource server and, after receiving the data required for executing the transaction, updates the received data according to the execution result.
